(19) United States
(12) Patent Application Publication
(10) Pub. No.: US 2026/0088274 A1
(43) Pub. Date: Mar. 26, 2026

(54) CHARGING-DISCHARGING APPARATUS AND METHOD OF CONTROLLING THE SAME

(71) Applicant: SK On Co., Ltd., Seoul (KR)

(72) Inventors: Yun Jo JUNG, Daejeon (KR); Eun Sol GO, Daejeon (KR); Yun Ho NOH, Daejeon (KR); Geon Hee LEE, Daejeon (KR); Yong Il CHO, Daejeon (KR)

(21) Appl. No.: 19/337,915

(22) Filed: Sep. 24, 2025

(30) Foreign Application Priority Data
Sep. 24, 2024 (KR) 10-2024-0129009

(51) Int. Cl. H01M 4/04; H01M 10/44; H02J 7/00

(52) U.S. Cl. CPC H01M 4/0447; H01M 10/441; H01M 10/443; H02J 7/875

(57) ABSTRACT

The present disclosure relates to a charging-discharging apparatus and a method of controlling thereof according to an embodiment of the present disclosure includes: a stage portion including a plurality of arrangement regions for accommodating each of a plurality of battery groups grouping neighboring battery cells among a plurality of battery cells and a plurality of temperature sensor for measuring the temperature of the plurality of arrangement regions; a charging-discharging module configured to charge and discharge the plurality of battery cells; a plurality of blowers configured to flow air toward the plurality of arrangement regions; and a controller to configured to control the plurality of temperature sensors and the plurality of blowers; wherein the controller individually may change the airflow, which is the air rate per unit time of the plurality of blowers, based on each measured temperature measured by the plurality of temperature sensors.

### CROSS-REFERENCE TO RELATED PATENT APPLICATION

The present application claims priority under 35 U.S.C. § 119 (a) to Korean patent application number 10-2024-0129009 filed on Sep. 24, 2024, in the Korean Intellectual Property Office, the entire disclosure of which is incorporated by reference herein.

### BACKGROUND OF THE INVENTION

### 1. Field

The present disclosure relates to a charging-discharging apparatus and a control method thereof. More particularly, it relates to a charging-discharging apparatus and a control method for improving the manufacturing process of a secondary battery.

### 2. Description of the Related Art

The conventional manufacturing process of a secondary battery (or battery cell) requires a charging and discharging process to charge and discharge the battery cell after the battery cell is assembled. A charging-discharging apparatus is one of the devices used in the charge and discharge process. A conventional charging-discharging apparatus sucks in and blows outside air at a certain speed towards the battery cell to dissipate the heat generated during the charging and discharging of the battery cell.

However, blowing outside air at a constant speed towards the battery cell may cause temperature deviations and capacity deviations depending on the location of the battery cell. Since the battery cells with severe temperature deviation and capacity deviation are treated as defective, the efficiency of the battery cell manufacturing process may be reduced. In particular, as the trend of charge and discharge batteries has recently become larger and higher capacity, it is becoming more important to manage the temperature deviation depending on the location of the battery cell.

In accordance with one aspect of the present disclosure, the efficiency of a battery cell manufacturing process may be improved.

In accordance with another aspect of the present disclosure, a charging-discharging apparatus capable of simultaneously charging and discharging more battery cells of higher capacity may be provided.

In accordance with another aspect of the present disclosure, a temperature deviation due to the position of the battery cells in the charging-discharging apparatus may be reduced.

In accordance with another aspect of the present disclosure, a capacity deviation due to the position of the battery cells in the charging-discharging apparatus may be reduced.

The battery cells produced by the charging and discharging apparatus according to the present disclosure can be widely applied in the field of green technology, such as electric vehicles, battery charging stations, energy storage systems (ESS), and other green technologies such as photovoltaics and wind power utilizing batteries. In addition, the battery cells produced by the charging-discharging apparatus according to the present disclosure can be used in eco-friendly mobility, including electric vehicles and hybrid vehicles to prevent climate change by reducing air pollution and greenhouse gas emissions.

### SUMMARY OF THE INVENTION

A charging-discharging apparatus according to an embodiment of the present disclosure may comprise: a stage portion including a plurality of arrangement regions for accommodating each of a plurality of battery groups grouping neighboring battery cells among a plurality of battery cells and a plurality of temperature sensor for measuring the temperature of the plurality of arrangement regions; a charging-discharging module configured to charge and discharge the plurality of battery cells; a plurality of blowers configured to flow air toward the plurality of arrangement regions; and a controller to configured to control the plurality of temperature sensors and the plurality of blowers; wherein the controller individually may change the airflow, which is the air rate per unit time of the plurality of blowers, based on each measured temperature measured by the plurality of temperature sensors.

In an embodiment, the stage portion may include a first stage, a second stage, and a third stage, each of which accommodates a plurality of battery cells, and the second stage may be disposed on the first stage, and the third stage may be disposed on the second stage.

In an embodiment, the plurality of arrangement regions of the first stage may include a first arrangement region accommodating a first battery group of some of battery cells grouped into a predetermined first arrangement number, the plurality of arrangement regions of the second stage may include a second arrangement region accommodating a second battery group of some of the other battery cells grouped into a predetermined second arrangement number, the plurality of arrangement regions of the third stage may include a third arrangement region located between the first arrangement region and the second arrangement region and accommodating a third battery group of the remained battery cells among the plurality of battery cells grouped into a predetermined third arrangement number, and the temperature sensors of the first stage may include a first temperature sensor for measuring the temperature of the first arrangement region, and the temperature sensors of the second stage may include a second temperature sensor for measuring the temperature of the second arrangement region, and the temperature sensors of the third stage may include a third temperature sensor for measuring the temperature of the third arrangement region.

In an embodiment, the controller may control each airflow of the plurality of blowers as a first airflow when the overall average temperature of the plurality of arrangement regions measured by the plurality of temperature sensors is equal to or higher than a predetermined first reference temperature, and may control each airflow of the plurality of blowers as a second airflow when the overall average temperature of the plurality of arrangement regions is equal to or lower a predetermined second reference temperature.

In an embodiment, the controller may compare the sum of the differences between the overall average temperature of the plurality of arrangement regions and each average temperature of the plurality of arrangement regions with a preset reference difference value and may control the respective airflow of the plurality of blowers when the overall average temperature of the plurality of arrangement regions is above the second reference temperature and is below the first reference temperature.

In an embodiment, the controller may compare each average temperature of the plurality of arrangement regions with a preset target temperature and controls the respective airflow of the plurality of blower when the overall average temperature of the plurality of arrangement regions is above the second reference temperature and is below the first reference temperature.

In an embodiment, the controller may start charging by the charging-discharging module until a preset offset time is reached and controls the airflow of each of the plurality of blowers to a preset offset airflow.

In an embodiment, the controller repeatedly may measure the temperature of the plurality of arrangement regions by the plurality of temperature sensors every time a preset measurement cycle elapsed.

In another embodiment, a method for controlling a charging-discharging apparatus, which includes a stage portion for accommodating a plurality of battery cells, a charging-discharging module configured to charge and discharge each of the plurality of battery cells, and a plurality of blowers configured to blow outside air toward the plurality of battery cells with the plurality of battery cells interposed therebetween, may comprise: a step of measuring each measured temperature of a plurality of arrangement regions in which battery groups grouping the plurality of battery cells are placed by a temperature sensor disposed on the stage portion; and a step of controlling the airflow of the plurality of blowers based on each measured temperature.

In another embodiment, the method may further comprise: a step of initiating the plurality of blowers and the charging-discharging module; and a step of controlling the airflow of the plurality of blowers with a preset offset airflow for a preset offset time after the step of initiating the plurality of blowers and the charging-discharging module, prior to the step of measuring each measurement temperature of the plurality of arrangement regions.

In another embodiment, the method may further comprise: a step of determining whether charging and discharging of the plurality of battery cells is completed by the charging-discharging module after the step of controlling the airflow of the plurality of blowers based on each measured temperature; and a step of turning off the operation of the plurality of blowers and the charging-discharging module when the charging and discharging of the plurality of battery cells is completed.

In another embodiment, the step of measuring each measurement temperature of the plurality of arrangement regions, the step of controlling the airflow of the plurality of blower based on each measurement temperature, and the step of determining whether charging and discharging of the plurality of battery cells is completed may be repeated when a preset measurement cycle has elapsed during charging and discharging of the plurality of battery cells.

In another embodiment, the method may further comprise: a step of determining a battery cell among the plurality of battery cells in which a temperature deviation or a capacity deviation is above a preset temperature deviation or a preset capacity deviation is defective after the step of turning off the operation of the plurality of blowers and the charging-discharging module.

In another embodiment, the airflow of each of the plurality of blowers may be controlled to a first airflow when the overall average temperature of the plurality of arrangement regions measured by the plurality of temperature sensors is equal to or higher than a predetermined first reference temperature, and the airflow of each of the plurality of blowers is controlled to a second airflow when the overall average temperature of the plurality of arrangement regions measured by the plurality of temperature sensors is equal to or lower than a predetermined second reference temperature in the step of controlling the airflow of the plurality of blowers.

In another embodiment, the predetermined first reference temperature may be 45° C., and the predetermined second reference temperature may be 25° C.

In another embodiment, each airflow of the plurality of blowers may be controlled to a third airflow when the overall average temperature of the plurality of arrangement regions is above the predetermined second reference temperature and is below the predetermined first reference temperature and when the sum of the absolute values of the differences between the overall average temperature of the plurality of arrangement regions and each average temperature of the plurality of arrangement regions is equal to or higher than a preset reference difference value, and each airflow of the plurality of blowers may be controlled to a fourth airflow when the sum of the absolute values of the differences between the overall average temperature of the plurality of arrangement regions and each average temperature of the plurality of arrangement regions is less than a preset reference difference value in the step of controlling the airflow of the plurality of blowers.

In another embodiment, the reference difference value may be 0.2° C.

In another embodiment, the airflow of each of the plurality of blowers is controlled to a third airflow when the overall average temperature of the plurality of arrangement regions is above the predetermined second reference temperature and is below the predetermined first reference temperature and when each average temperature of the plurality of arrangement regions is equal to or higher than a preset target temperature, and the airflow of each of the plurality of blowers is controlled to a fourth airflow when each average temperature of the plurality of arrangement regions is below the target temperature.

In accordance with one aspect of the present disclosure, the efficiency of a battery cell manufacturing process may be improved.

In accordance with another aspect of the present disclosure, a charging-discharging apparatus capable of simultaneously charging and discharging more battery cells of higher capacity may be provided.

In accordance with another aspect of the present disclosure, a temperature deviation due to the position of the battery cells in the charging-discharging apparatus may be reduced.

In accordance with another aspect of the present disclosure, a capacity deviation due to the position of the battery cells in the charging-discharging apparatus may be reduced.

### BRIEF DESCRIPTION OF THE DRAWINGS

FIG. 1 illustrates an example of a charging-discharging apparatus according to the present disclosure viewed from the front.

FIG. 2 illustrates schematically an example stage portion according to the present disclosure viewed from the side.

FIG. 3 is a control block diagram of a charging-discharging apparatus according to the present disclosure.

FIG. 4 is a flowchart illustrating an example control method of a charging-discharging apparatus according to the present disclosure.

FIG. 5 is a flowchart illustrating an example of controlling the airflow of a plurality of blowers based on each measured temperature.

FIG. 6 is a flowchart illustrating another example of controlling the airflow of a plurality of blowers based on each measured temperature.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

The use of terms such as “first,” “second,” “third,” and the like to precede components referred to herein is intended only to avoid confusion as to the components to which they refer and does not indicate any order, importance, or master-servant relationship among the components. For example, it is possible to practice an invention that includes only the second component without the first component.

As used in this disclosure, expressions in the singular include the plural unless the context clearly indicates otherwise.

As used herein, the terms battery, secondary battery, or cell are used interchangeably with battery cell.

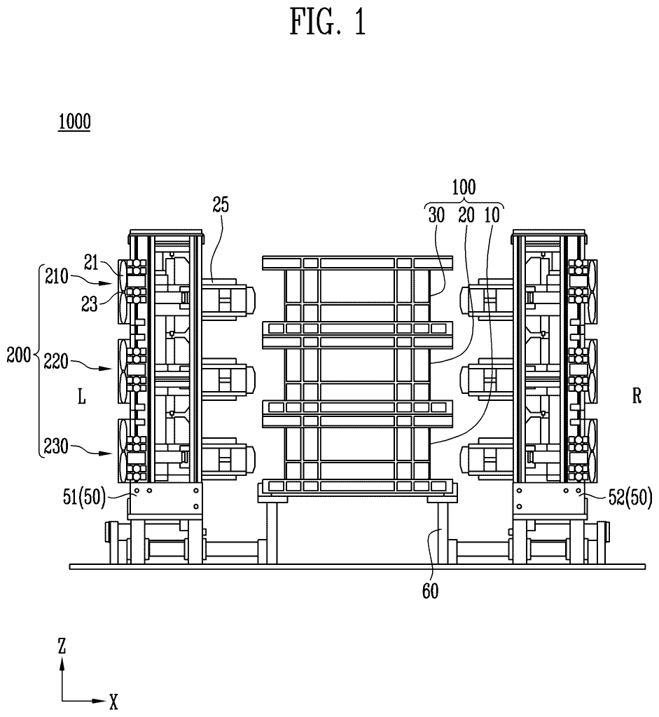

FIG. 1 illustrates an example of a charging-discharging apparatus according to the present disclosure viewed from the front.

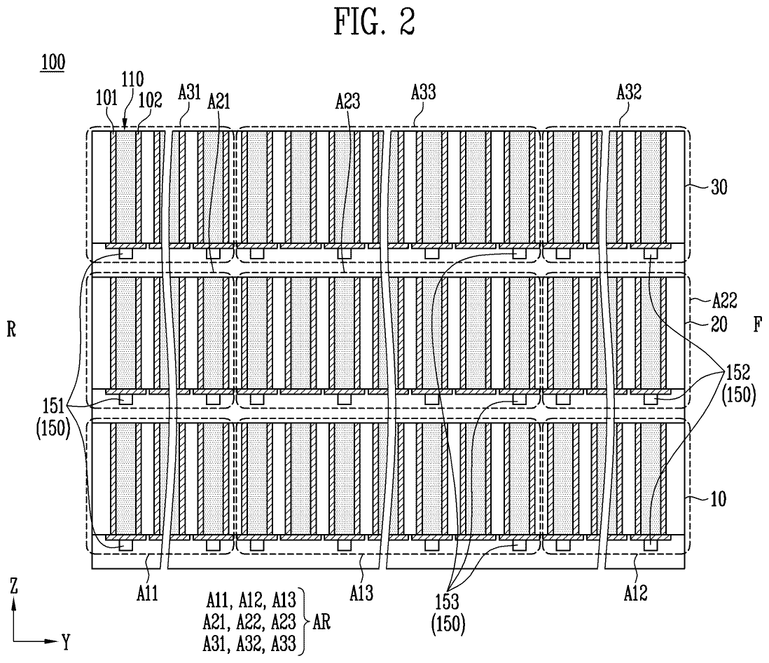

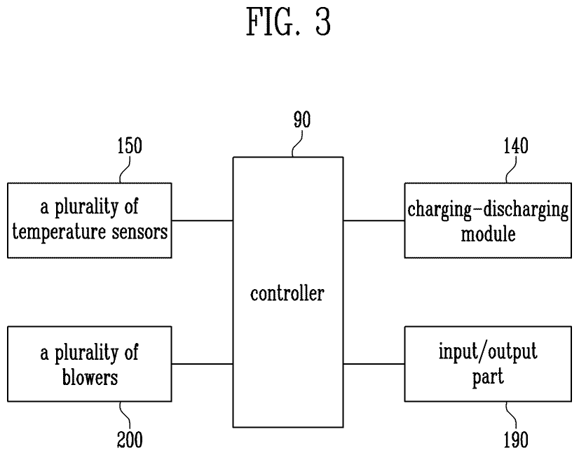

A charging-discharging apparatus 1000 according to the present disclosure may include a stage portion 100 accommodating a plurality of battery cells 110 (see FIG. 2), a charging-discharging module 140 (see FIG. 3) for charging and discharging each of the plurality of battery cells 110, and a plurality of blowers 200 for blowing outside air between the plurality of battery cells 110 and toward the plurality of battery cells 110.

The charging-discharging apparatus 1000 may refer to a battery cell charging-discharging apparatus used to charge and discharge battery cells in an online or offline process.

While the type of the plurality of battery cells 110 has been described herein as a pouch type, the type of the plurality of battery cells 110 may be a round or square type, without limitation.

The stage portion 100 may accommodate the plurality of battery cells 110. Referring to FIG. 1, for example, the stage portion 100 may be in the form of three stacked stages along the height direction (Z-direction) of the charging-discharging apparatus 1000. That is, the stage portion 100 may comprise a first stage 10, a second stage 20, and a third stage 30, each accommodating the plurality of battery cells 110, wherein the second stage 20 may be disposed on the first stage 10, and the third stage 30 may be disposed on the second stage 20.

However, this is only an example, and the number of stacked units of the stage portion 100 may be varied.

The stage portion 100 may be supported by the support portion 60.

The plurality of blowers 200 may draw in and blow outside air towards the plurality of battery cells 110. The plurality of blowers 200 may be disposed along the width direction (X-direction) of the charging-discharging apparatus 1000, spaced apart from the stage portion 100.

The plurality of blowers 200 may draw in and blow outside air toward each stage of the stage portion 100. For example, referring to FIG. 1, the plurality of blowers 200 may include a first blower 210 for blowing outside air toward the first stage 10, a second blower 220 for blowing outside air toward the second stage 20, and a third blower 230 for blowing outside air toward the third stage 30.

The first blower 210 may be provided in a plurality, wherein the plurality of first blowers 210 may be arranged in parallel with the first stage 10 along a front-to-back direction of the charging-discharging apparatus 1000.

The second blower 220 may be provided in a plurality, wherein the plurality of second blowers 220 may be arranged in parallel with the second stage 20 along a front-to-back direction of the charging-discharging apparatus 1000.

Similarly, the third blower 230 may be provided in a plurality, such that the plurality of third blowers 230 are disposed in parallel with the third stage 30 along a front-to-back direction of the charging-discharging apparatus 1000.

The plurality of blowers 200 may include a motor (not shown) for generating rotational force, a blower fan 21 coupled to a rotational shaft of the motor, and a blowing duct 25 for transporting air from outside air sucked in by the blower fan 21 towards the plurality of battery cells 110.

Furthermore, a center portion of the blower fan 21 may be coupled to a rotational shaft of the motor. The controller 90, which will be described later, may control the airflow of the plurality of blowers 200. The airflow may be defined as the amount of air per unit time traveling from any one of the plurality of blowers 200 past the blower fan 21 towards the stage portion 100. If the plurality of blowers 200 includes a blower fan 21, the airflow will be proportional to the rotational speed of the blower fan 21.

The charging-discharging apparatus 1000 according to the present disclosure may further comprise a blowing frame 50 supporting the plurality of blowers 200. Since the plurality of blowers 200 are disposed between the stage portions 100, the blowing frame 50 may include a first blowing frame 51 positioned on a left side (L-direction) of the stage portions 100 and a second blowing frame 52 positioned on a right side (R-direction) of the stage portions 100.

FIG. 2 illustrates schematically an example stage portion according to the present disclosure viewed from the side.

As mentioned above, the stage portion 100 may comprise a plurality of stages 10, 20, 30 stacked along the height direction of the charging-discharging apparatus 1000. While FIG. 2 illustrates three stages, this is by way of example only, and the number of stages is not limited to three.

The stage portion 100 may include a plurality of arrangement regions AR for each of a plurality of battery groups grouping neighboring battery cells 110 of the plurality of battery cells 110, and a plurality of temperature sensors 150 for measuring the temperature of the plurality of arrangement regions AR.

The plurality of battery cells 110 may be grouped into a predetermined number of neighboring battery cells 110 to form a plurality of battery groups. Each of the plurality of battery groups may be accommodated in an arrangement area of one of the plurality of stages 10, 20, 30, i.e., the plurality of arrangement areas AR refers to a space for accommodating the plurality of battery groups.

For example, referring to FIG. 2, the first plurality of arrangement regions A11, A12, A13 of the first stage 10, the second plurality of arrangement regions A21, A22, A23 of the second stage 20, and the third plurality of arrangement regions A31, A32, A33 of the third stage 30 each comprise a first arrangement region A11, A21, A31 accommodating a first battery group grouping some of the battery cells 110 of the plurality of battery cells 110 in a predetermined first arrangement number, a second arrangement area A12, A22, A32 for accommodating a second battery group grouping the battery cells 110 of another portion of the plurality of battery cells 110 in a predetermined second arrangement number, and a second arrangement area A12, A12, A22, A32, and a third arrangement region A13, A23, A33 located between the first arrangement region A11, A21, A31 and the second arrangement region A12, A22, A32 and accommodating a third battery group grouping the remaining battery cells 110 of the plurality of battery cells 110 in a predetermined third arrangement number.

Meanwhile, in each of the stages 10, 20, 30, the length of the third arrangement region A13, A23, A33 along the front-to-back direction (Y-direction) may be longer than the length of the first arrangement region A11, A21, A31 and the length of the second arrangement region A12, A22, A32.

Thus, in each of the stages 10, 20, 30, the third arrangement number may be greater than the first arrangement number and the second arrangement number.

The stage portion 100 may further comprise jigs 101, 102 that removably support each of the plurality of battery cells 110, i.e., one battery cell 110 may be disposed between the jigs 101, 102.

The jigs 101, 102 may be located inside the blower duct 25.

Further, the charging-discharging apparatus 1000 according to the present disclosure may include a plurality of temperature sensors 150 for measuring the temperature of the plurality of arrangement regions AR.

For example, the plurality of temperature sensors 150 may include a plurality of temperature sensors in each of the plurality of arrangement regions AR to better measure the temperature of the plurality of arrangement regions AR, i.e., the number of temperature sensors in any one arrangement region may be a plurality.

Accordingly, the temperature measured by the plurality of temperature sensors in any one deployment area may be an average value of the plurality of temperature sensors.

For example, the plurality of arrangement regions A11, A12, A13 of the first stage 10, the plurality of arrangement regions A21, A22, A23 of the second stage 20, and the plurality of arrangement regions A31, A32, A33 of the third stage 30 may each include a first arrangement region A11, A21, A31, a second arrangement area A12, A22, A32 accommodating a second battery group grouping the battery cells 110 of another portion of the plurality of battery cells 110 in a predetermined second arrangement number, and a third arrangement area A11, A21, A31 located between the first arrangement area A11, A21, A31 and the second arrangement area A12, A22, A32, and may include a third arrangement region A13, A23, A33 for accommodating a third battery group grouping the remaining battery cells 110 of the plurality of battery cells 110 into a predetermined third arrangement number.

Furthermore, the plurality of temperature sensors 150 of the first stage 10, the plurality of temperature sensors 150 of the second stage 20, and the plurality of temperature sensors 150 of the third stage 30 each comprise a first temperature sensor 151 for measuring the temperature of the first arrangement area A11, A21, A31, a second temperature sensor 152 for measuring the temperature of the second arrangement area A12, A22, A32, and a third temperature sensor 153 for measuring the temperature of the third arrangement area A13, A23, A33.

Further, the first temperature sensors 151, the second temperature sensors 152, and the third temperature sensors 153 may each include a plurality of temperature sensors.

The plurality of temperature sensors 150 may be located at a lower portion of the jigs 101, 102 in the stage portion 100. Thus, the plurality of temperature sensors 150 may be located at the bottom of one side of the jigs 101, 102 at each of the stages 10, 20, 30 or at the bottom of the jigs 101, 102.

Furthermore, referring to FIGS. 1 and 2, the first blower 210 may comprise a plurality of first blowers 210. Some of the plurality of first blowers 210 may blow air toward the first arrangement area A11 of the first stage 10, other of the plurality of first blowers 210 may blow air toward the second arrangement area A12 of the first stage 10, and the remaining of the plurality of first blowers 210 may blow air toward the third arrangement area A13 of the first stage 10.

Furthermore, the second blower 220 may be provided in a plurality. Some of the plurality of second blowers 220 may blow air toward the first arrangement area A21 of the second stage 20, another of the plurality of second blowers 220 may blow air toward the second arrangement area A22 of the second stage 20, and the remaining of the plurality of second blowers 220 may blow air toward the third arrangement area A23 of the second stage 20.

Similarly, the third blower 230 may be provided in a plurality. Some of the plurality of third blowers 230 may blow air towards the first arrangement area A31 of the third stage 30, another of the plurality of third blowers 230 may blow air towards the second arrangement area A32 of the third stage 30, and the remaining of the plurality of third blowers 230 may blow air towards the third arrangement area A33 of the third stage 30.

FIG. 3 is a control block diagram of a charging-discharging apparatus according to the present disclosure.

A charging-discharging apparatus 1000 (see FIG. 1) according to the present disclosure includes a stage portion 100 comprising a plurality of battery cells 110, each of the plurality of battery cells 110 having a plurality of arrangement regions AR for accommodating a plurality of battery groups grouping neighboring battery cells 110 and a plurality of temperature sensors 150 for measuring a temperature of the plurality of arrangement regions AR (See FIG. 1), a charging-discharging module 140 configured to charge and discharge the plurality of battery cells 110, a plurality of blowers 200 configured to flow air toward the plurality of arrangement regions AR, and a controller 90 that controls the plurality of temperature sensors 150 and the plurality of blowers 200. And, based on each measured temperature measured by the plurality of temperature sensors 150, the controller 90 may individually change the airflow rate, which is the air rate per unit time, of the plurality of blowers 200.

The controller 90 may measure the temperature of the respective arrangement region by the plurality of temperature sensors 150 every time a predetermined measurement period elapses, and control the plurality of blowers 200 based thereon.

For example, the plurality of blowers 200 may include 12 blower fans 21 (see FIG. 1) for each of the stages 10, 20, 30 that are disposed side-by-side with each of the stages 10, 20, 30. The first arrangement areas A11, A21, A31 and the second arrangement areas A12, A22, A32 of each of the stages 10, 20, 30 may each include two blower fans 21, and the third arrangement areas A13, A23, A33 of each of the stages 10, 20, 30 may include eight blower fans 21.

Further, the plurality of temperature sensors 150 may include a first temperature sensors 151 for each of the stages 10, 20, 30, the second temperature sensors 152 may include two temperature sensors each, and the third temperature sensors 153 may include six temperature sensors.

However, this is an example only, and the number of the plurality of blowers 200 and the number of the plurality of temperature sensors 150 may be varied depending on the design.

The controller 90 may control the charging-discharging module 140 to charge and discharge the plurality of battery cells 110 accommodated in the stage portion 100. The charging-discharging module 140 may charge and discharge a certain number of the plurality of battery cells 110. Accordingly, the charging-discharging module 140 may be provided in a plurality for charging and discharging the plurality of battery cells 110.

Furthermore, the controller 90 may determine that the charging and discharging of the plurality of battery cells 110 is complete by the charging-discharging module 140.

Furthermore, the controller 90 may receive commands from the user, or control the input/output part 190 that shows the status of the execution and the result of the execution.

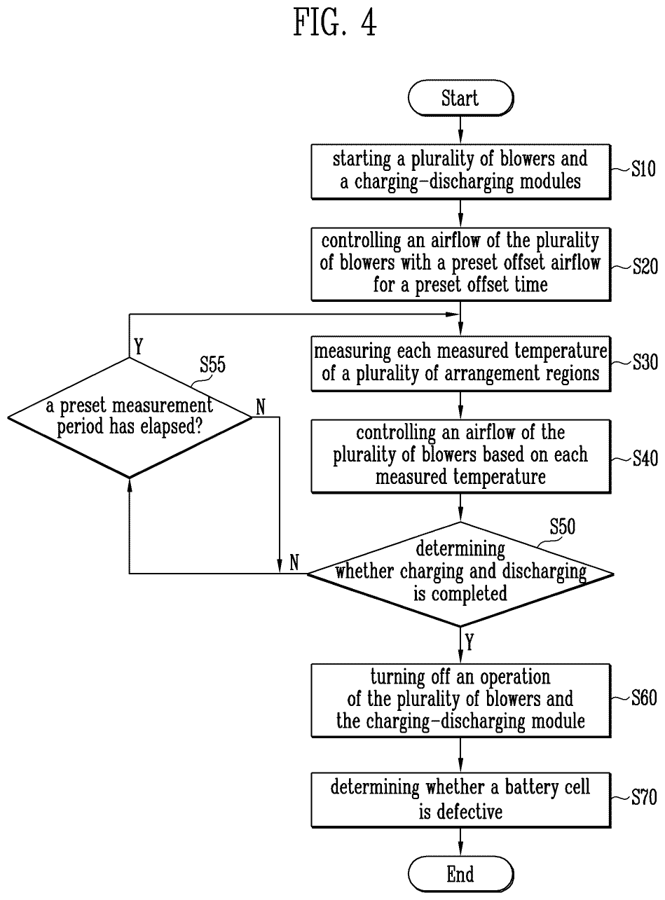

FIG. 4 is a flowchart illustrating an example control method of a charging-discharging apparatus according to the present disclosure.

Referring to FIGS. 2 and 4, a control method of a charging-discharging apparatus 1000 comprising a stage portion 100 accommodating a plurality of battery cells 110, a charging-discharging module 140 (see FIG. 3) for charging and discharging each of the plurality of battery cells 110, and a plurality of blowers 200 (see FIG. 1) for blowing outside air toward the plurality of battery cells 110 between the plurality of battery cells 110. The control method of the charging-discharging apparatus 1000 according to the present disclosure may include a step S30 of measuring, by a temperature sensor 150 disposed in the stage portion 100, each measured temperature of a plurality of arrangement regions AR in which a group of batteries grouping neighboring battery cells 110 of the plurality of battery cells 110 is placed, and a step S40 of controlling an airflow of the plurality of blowers 200 based on each measured temperature.

The control method of the charging-discharging apparatus 1000 according to the present disclosure comprises a step S10 of starting the plurality of blowers 200 and the charging-discharging modules 140, and after the step S10 of starting the plurality of blowers 200 and the charging-discharging modules 140, before the step S30 of measuring the respective measuring temperature of the plurality of arrangement regions AR, the method may further comprise the step S20 of controlling the airflow of the plurality of blowers 200 with a preset offset airflow for a preset offset time.

The step S10 of initiating the plurality of blowers 200 and the charging-discharging module 140 may be initiated by the controller 90 accommodating a start input of the charging-discharging apparatus 1000, i.e., by the input/output part 190, a user may initiate the operation of the charging-discharging apparatus 1000.

The step S20 of controlling the airflow rate of the plurality of blowers 200 with the offset airflow rate is to control the airflow rate of the plurality of blowers 200 during an offset time required for warming up after startup of the charging-discharging apparatus 1000 until the charging-discharging apparatus 1000 reaches a steady state.

In other words, the controller 90 may start charging and discharging by the charging-discharging module 140 until a preset offset time is reached, and control the respective airflow of the plurality of blowers 200 to a preset offset airflow.

For example, the offset time may be 10 minutes.

Further, the offset airflow may be a set value of airflow set to individually control the airflow of the plurality of blowers 200. For example, at the offset airflow, the controller 90 may control the airflow of the first blower 210 (see FIG. 1) to be 100% of the maximum airflow of the first blower 210, control the airflow of the second blower 220 (see FIG. 1) to be 100% of the maximum airflow of the second blower 220, and control the airflow of the third blower 230 (see FIG. 1) to be 50% of the maximum airflow of the third blower 230.

Further, the control method of the charging-discharging apparatus 1000 according to the present disclosure further comprises the step S40 of controlling an airflow of the plurality of blowers 200 based on the each measured temperature, followed by the step S50 of determining whether charging and discharging of the plurality of battery cells 110 by the charging-discharging module 140 is completed, and upon completion of the charging and discharging of the plurality of battery cells 110, further comprising the step S60 of turning off the operation of the plurality of blowers 200 and the charging-discharging module 140.

In a step S50 of determining that the charging and discharging of the plurality of battery cells 110 is complete, the control method of the charging-discharging apparatus 1000 according to the present disclosure may turn off the operation of the plurality of blowers 200 and the charging-discharging module 140 upon determining that the charging and discharging of the plurality of battery cells 110 is complete by the charging-discharging module 140.

Furthermore, the control method of the charging-discharging apparatus 1000 according to the present disclosure may repeat the step of measuring each measured temperature of the plurality of arrangement regions AR S30, the step S40 of controlling the airflow of the plurality of blowers 200 based on the each measured temperatures S55, and the step S50 of determining that the charging and discharging of the plurality of battery cells 110 is completed when a preset measurement period elapses during the charging and discharging of the plurality of battery cells 110.

In other words, the controller 90 may repeatedly measure the temperature of the plurality of arrangement regions AR through the plurality of temperature sensors 150 every time a preset measurement period elapse.

And, the controller 90 may control the airflow of the plurality of blowers 200 based on each measured temperature, and determine that the charging and discharging of the plurality of battery cells 110 is completed through the charging-discharging module 140.

At this time, the control method of the charging and discharging apparatus 1000 according to the present disclosure includes the step of determining that the charging and discharging of the plurality of battery cells 110 has not yet been completed through the charging-discharging module 140, and when a preset measurement period during the charging and discharging of the plurality of battery cells 110 has elapsed S55, the step S30 of measuring each measuring temperature of the plurality of arrangement regions AR, the step S40 of controlling the airflow of the plurality of blowers 200 based on each measuring temperature, and the step S50 of determining that the charging and discharging of the plurality of battery cells 110 is completed can be repeatedly performed.

By repeatedly performing the step S30 of measuring each measured temperature of the plurality of arrangement regions AR through the above measurement cycle, the step S40 of controlling the airflow of the plurality of blowers 200 based on each measured temperature, and the step S50 of determining that the charging and discharging of the plurality of battery cells 110 is completed, the control method of the charging-discharging apparatus 1000 according to the present disclosure can efficiently manage temperature deviations and capacity deviations of the plurality of battery cells.

For example, the measurement period may be 30 seconds.

Furthermore, the control method of the charging-discharging apparatus 1000 according to the present disclosure may further comprise, after the step S60 of turning off the operation of the plurality of blowers 200 and the charging-discharging module 140, a step S70 of determining that a battery cell 110 having a temperature deviation or a capacity deviation among the plurality of battery cells 110 that is above a predetermined deviation temperature or a predetermined deviation capacity is defective.

After the charging and discharging of the plurality of battery cells 110 is completed, if each measured temperature of the plurality of battery cells 110 measured through the temperature sensor 150 is above a predetermined number of median values, the control method of the charging-discharging apparatus 1000 according to the present disclosure may determine that the battery cells 110 having a final temperature deviation exceeding the predetermined number of median values are defective.

For example, the predetermined number may be 30, and the final temperature deviation may be 2.5° C.

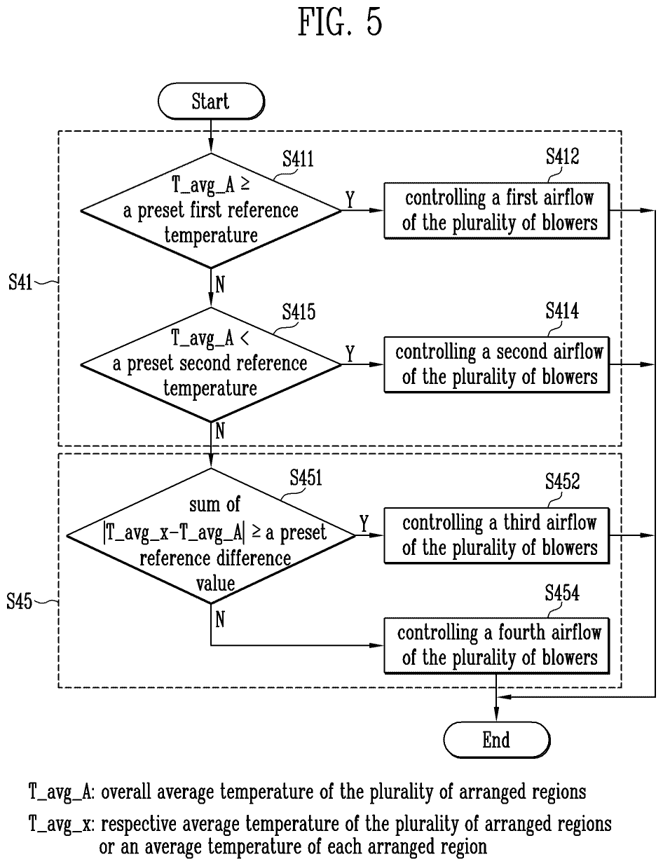

FIG. 5 is a flowchart illustrating a specific example of controlling the airflow of a plurality of blowers based on each measured temperature.

Referring to FIG. 5, the step S40 of controlling the airflow of the plurality of blowers 200 based on the each measured temperatures may include a step S41 of controlling the airflow of the plurality of blowers 200 based on an overall average temperature of the plurality of arrangement regions AR and a step S45 of controlling the airflow of the plurality of blowers 200 based on an absolute value of a difference between the respective average temperatures of the plurality of arrangement regions AR and the overall average temperature.

In the step S41 of controlling the airflow of the plurality of blowers 200 based on the overall average temperature of the plurality of arranged regions AR, the control method of the charging and discharging apparatus 1000 according to the present disclosure is performed when the overall average temperature T_avg_A of the plurality of arranged regions AR measured by the plurality of temperature sensors 150 is equal to or higher than a preset first reference temperature S411, When the overall average temperature T_avg_A of the plurality of arrangement regions AR measured by the temperature sensor 150 is below the preset first reference temperature S411, each airflow of the plurality of blowers 200 may be controlled S412 as a first airflow, and when the overall average temperature T_avg_A of the plurality of arrangement regions AR is below the preset second reference temperature S415, each airflow of the plurality of blowers 200 may be controlled S414 as a second airflow.

In one embodiment, the first reference temperature may be 45° C. and the second reference temperature may be 25° C.

The first reference temperature and the second reference temperature may vary depending on the number of the plurality of arrangement regions AR and the number of stacked stages of the stage portion 100.

Like the first airflow rate and the second airflow rate, the offset airflow rate may be a set of airflow rates set to individually control the airflow rate of the plurality of blowers 200.

For example, at the first airflow, the controller 90 may control an airflow of the first blower 210 (see FIG. 1) to be 100% of a maximum airflow of the first blower 210, control an airflow of the second blower 220 (see FIG. 1) to be 100% of a maximum airflow of the second blower 220, and control an airflow of the third blower 230 (see FIG. 1) to be 50% of a maximum airflow of the third blower 230.

In one example, at the second airflow, the controller 90 may control an airflow of the first blower 210 to be 20% of a maximum airflow of the first blower 210, control an airflow of the second blower 220 to be 20% of a maximum airflow of the second blower 220, and control an airflow of the third blower 230 to be 20% of a maximum airflow of the third blower 230.

Further, in the step S45 of controlling the airflow of the plurality of blowers 200 based on the value |T_avg_x−T_avg_A| of the difference T_avg_x between the respective average temperature T_avg_x of the plurality of arranged regions AR and the total average temperature T_avg_A of the plurality of arranged regions AR, the control method of the charging-discharging device 1000 according to the present disclosure is performed when the total average temperature of the plurality of arranged regions AR is above the second reference temperature and is below the first reference temperature, When the sum of the absolute value of the difference between the overall average temperature of the plurality of arrangement regions AR and the difference between the respective average temperatures of the plurality of arrangement regions AR is above the preset reference difference value S451, the respective airflow rate of the plurality of blowers 200 is controlled S452 as a third airflow rate, When the sum of the absolute value of the difference between the overall average temperature of the plurality of arrangement regions AR and the difference between the average temperature of each of the plurality of arrangement regions AR is less than the preset reference difference value, the respective airflow of the plurality of blowers 200 may be controlled as a fourth airflow S454.

In one embodiment, the threshold difference value may be 0.2° C. The reference difference value may vary depending on the number of the plurality of arrangement regions AR and the number of stacked stages of the stage portion 100.

The third and fourth airflow rates may also be airflow rate setpoints set to individually control the airflow rate of the plurality of blowers 200 under given conditions.

For example, in the third airflow rate, the controller 90 controls the airflow rate of the plurality of first blowers 210 (see FIG. 1) to 100% of the maximum airflow rate of the first blowers 210, and controls the airflow rate of the second blowers 220 (see FIG. 1) to 100% of the maximum airflow rate of the second blowers 220, wherein the airflow of the third blower 230 discharging air toward the first arrangement area A31 of the third stage 30 and the third blower 230 discharging air toward the second arrangement area A32 of the third stage 30 is controlled at 70% of the maximum airflow of each of the third blower 230. And, the airflow of the third blower 230 discharging air toward the third arrangement region A33 of the third stage 30 can be controlled to be 50% of the maximum airflow of each of the third blower 230.

For example, in the second airflow, the controller 90 may control an airflow of the first blower 210 to be 20% of a maximum airflow of the first blower 210, control an airflow of the second blower 220 to be 20% of a maximum airflow of the second blower 220, and control an airflow of the third blower 230 to be 20% of a maximum airflow of the third blower 230.

TABLE 1

| | Cumulative Sum of the | | |
|---|---|---|---|
| | deviation of temperature (° C.) | | |
| | | Comparative | |
| | | example 1 | |
| | Example 1 | (without airflow | |
| | (FIG. 5) | control) | Remark |
| A plurality of battery | 21 | 24 | 13% |
| cells accommodated in | | | |
| the first stage | | | |
| A plurality of battery | 21 | 28 | 25% |
| cells accommodated in | | | |
| the second stage | | | |
| A plurality of battery | 20 | 31 | 35% |
| cells accommodated in | | | |
| the third stage | | | |
| Sum | 62 | 83 | 25% |

Table 1 summarizes the sum of the deviation of the final temperature of the plurality of battery cells 110 accommodated in each of the stages 10, 20, 30 from the sum of the deviation of the final temperature of the plurality of battery cells 110 in Comparative Example 1 (without airflow control of the plurality of blowers 200) when the airflow of the plurality of blowers 200 is controlled using the control method illustrated in FIG. 5.

The final temperature deviation means the sum of the absolute value of the difference between the respective temperatures of the plurality of battery cells 110 accommodated in each of the respective stages 10, 20, 30 and the total average temperature of the plurality of battery cells 110 at the completion of charging and discharging of the plurality of battery cells 110 accommodated in each of the respective stages 10, 20, 30.

The remarks in Table 1 represent percentage values, wherein the difference between Comparative Example 1 and Example 1 is divided by Comparative Example 1 and multiplied by 100. Referring to Table 1, it can be seen that the temperature deviation of the plurality of battery cells 110 accommodated in each of the stages 10, 20, 30 is reduced when controlling the charging-discharging apparatus 1000 using the Example 1 compared to the Comparative Example 1.

Table 1 illustrates one example result utilizing a charging-discharging apparatus 1000 including three stages 10, 20, 30, but the charging-discharging apparatus 1000 according to the present disclosure is not limited to three stages.

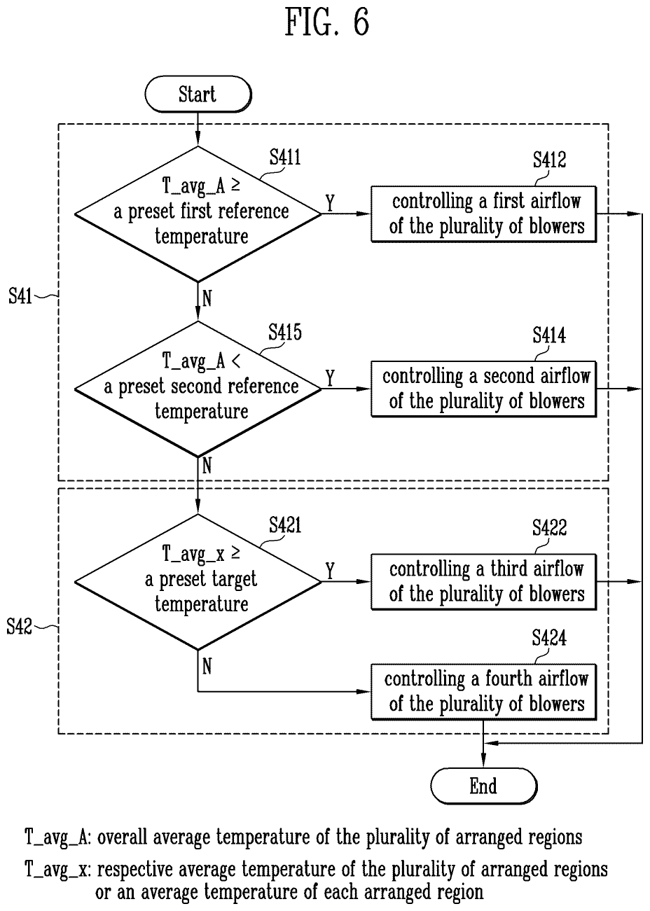

FIG. 6 is a flowchart illustrating another example of controlling the airflow of a plurality of blowers based on each measured temperature.

Referring to FIG. 6, the step S40 of controlling the airflow of the plurality of blowers 200 based on each measured temperatures may include a step S41 of controlling the airflow of the plurality of blowers 200 based on an overall average temperature of the plurality of arrangement regions AR and a step S42 of controlling the airflow of the plurality of blowers 200 based on each average temperature of the plurality of arrangement regions AR and a preset target temperature.

A description of the step S41 of controlling the airflow of the plurality of blowers 200 based on the overall average temperature of the plurality of arrangement regions AR is omitted because it is the same as described in FIG. 5.

In the step S42 of controlling the airflow rate of the plurality of blowers 200 based on the average temperature T_avg_x of each of the plurality of arrangement regions AR and the preset target temperature, the control method of the charging-discharging apparatus 1000 according to the present disclosure is performed when the overall average temperature of the plurality of arrangement regions AR is above the second reference temperature and below the first reference temperature, When the respective average temperature T_avg_x of the plurality of arrangement regions AR is the preset target temperature S421, the respective airflow of the plurality of blowers 200 may be controlled to a third airflow S422, and when the respective average temperature of the plurality of arrangement regions AR is below the target temperature, the respective airflow of the plurality of blowers 200 may be controlled to a fourth airflow S424.

The third and fourth airflow rates may also be airflow rate setpoints set to individually control airflow rates of the plurality of blowers 200 under given conditions.

For example, in the third airflow rate, the controller 90 controls the airflow rate of the plurality of first blowers 210 (see FIG. 1) to 100% of the maximum airflow rate of the first blowers 210, and controls the airflow rate of the second blowers 220 (see FIG. 1) to 100% of the maximum airflow rate of the second blowers 220, wherein the airflow of the third blower 230 discharging air toward the first arrangement area A31 of the third stage 30 and the third blower 230 discharging air toward the second arrangement area A32 of the third stage 30 is controlled at 70% of the maximum airflow of each of the third blower 230. Further, the airflow of the third blower 230 discharging air toward the third arrangement region A33 of the third stage 30 can be controlled to be 50% of the maximum airflow of each of the third blower 230.

In one example, at the second airflow, the controller 90 may control an airflow of the first blower 210 to be 20% of a maximum airflow of the first blower 210, control an airflow of the second blower 220 to be 20% of a maximum airflow of the second blower 220, and control an airflow of the third blower 230 to be 20% of a maximum airflow of the third blower 230.

In contrast, in the step S42 of controlling the airflow of the plurality of blowers 200 based on the average temperature of each of the plurality of arrangement regions AR and the predetermined target temperature, the control method of the charging-discharging apparatus 1000 according to the present disclosure controls the airflow of each of the plurality of blowers 200 when the overall average temperature of the plurality of arrangement regions AR is above the second reference temperature and below the first reference temperature, when the respective average temperature of each of the plurality of arrangement regions AR is equal to or higher than a predetermined target temperature S421, the respective airflow of the plurality of blowers 200 may be controlled as a fifth airflow, and when the respective average temperature of the plurality of arrangement regions AR is below the target temperature, the respective airflow of the plurality of blowers 200 may be controlled as a sixth airflow.

The fifth and sixth airflow rates may also be airflow rate set values set to individually control airflow rates of the plurality of blowers 200 under given conditions.

TABLE 2

| | Cumulative Sum of capacity | | |
|---|---|---|---|
| | deviation (%) | | |
| | | Comparative | |
| | | example 2 | |
| | Example 2 | (without airflow | |
| | (FIG. 6) | control) | Remark |
| A plurality of battery | 20 | 22 | 9% |
| cells accommodated in | | | |
| the first stage | | | |
| A plurality of battery | 16 | 19 | 16% |
| cells accommodated in | | | |
| the second stage | | | |
| A plurality of battery | 19 | 21 | 10% |
| cells accommodated in | | | |
| the third stage | | | |
| Sum | 55 | 62 | 11% |

Table 2 summarizes the sum of the final capacity deviations of the plurality of battery cells 110 accommodated in each of the stages 10, 20, 30 when controlling the airflow of the plurality of blowers 200 utilizing the control method (Example 2) illustrated in FIG. 6, and the sum of the final capacity deviations of the plurality of battery cells 110 in Comparative Example 1 (without controlling the airflow of the plurality of blowers 200).

The final capacity deviation means the sum of the absolute value of the difference between the respective capacities of the plurality of battery cells 110 accommodated in each of the stages 10, 20, 30 and the total average capacity of the plurality of battery cells 110 accommodated in each of the stages 10, 20, 30 upon completion of charging and discharging of the plurality of battery cells 110 accommodated in each of the stages 10, 20, 30.

The remarks in Table 2 represent percentage values, wherein the difference between Comparative Example 2 and Example 2 is divided by Comparative Example 2 and multiplied by 100. Referring to Table 2, it can be seen that the deviation in capacity of the plurality of battery cells 110 accommodated in each of the stages 10, 20, 30 is reduced when controlling the charging-discharging apparatus 1000 using the above Example 2 compared to the above Comparative Example 2.

Table 2 illustrates one example result utilizing a charging-discharging apparatus 1000 including three stages 10, 20, 30, but the charging-discharging apparatus 1000 according to the present disclosure is not limited to three stages.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A charging-discharging apparatus comprising:
a stage portion including a plurality of arrangement regions for accommodating each of a plurality of battery groups grouping neighboring battery cells among a plurality of battery cells and a plurality of temperature sensor for measuring the temperature of the plurality of arrangement regions;
a charging-discharging module configured to charge and discharge the plurality of battery cells;
a plurality of blowers configured to flow air toward the plurality of arrangement regions; and
a controller to configured to control the plurality of temperature sensors and the plurality of blowers;
wherein the controller individually changes the airflow, which is the air rate per unit time of the plurality of blowers, based on each measured temperature measured by the plurality of temperature sensors.

2. The charging-discharging apparatus according to claim 1, wherein the stage portion includes a first stage, a second stage, and a third stage, each of which accommodates a plurality of battery cells, and the second stage is disposed on the first stage, and the third stage is disposed on the second stage.

3. The charging-discharging apparatus according to claim 2, wherein the plurality of arrangement regions of the first stage include a first arrangement region accommodating a first battery group of some of battery cells grouped into a predetermined first arrangement number,
the plurality of arrangement regions of the second stage include a second arrangement region accommodating a second battery group of some of the other battery cells grouped into a predetermined second arrangement number,
the plurality of arrangement regions of the third stage include a third arrangement region located between the first arrangement region and the second arrangement region and accommodating a third battery group of the remained battery cells among the plurality of battery cells grouped into a predetermined third arrangement number, and
wherein the temperature sensors of the first stage include a first temperature sensor for measuring the temperature of the first arrangement region, and the temperature sensors of the second stage include a second temperature sensor for measuring the temperature of the second arrangement region, and the temperature sensors of the third stage include a third temperature sensor for measuring the temperature of the third arrangement region.

4. The charging-discharging apparatus according to claim 1, wherein the controller controls each airflow of the plurality of blowers as a first airflow when the overall average temperature of the plurality of arrangement regions measured by the plurality of temperature sensors is equal to or higher than a predetermined first reference temperature, and controls each airflow of the plurality of blowers as a second airflow when the overall average temperature of the plurality of arrangement regions is equal to or lower a predetermined second reference temperature.

5. The charging-discharging apparatus according to claim 4, wherein the controller compares the sum of the differences between the overall average temperature of the plurality of arrangement regions and each average temperature of the plurality of arrangement regions with a preset reference difference value and controls the respective airflow of the plurality of blowers when the overall average temperature of the plurality of arrangement regions is above the second reference temperature and is below the first reference temperature.

6. The charging-discharging apparatus according to claim 5, wherein the controller compares each average temperature of the plurality of arrangement regions with a preset target temperature and controls the respective airflow of the plurality of blower when the overall average temperature of the plurality of arrangement regions is above the second reference temperature and is below the first reference temperature.

7. The charging-discharging apparatus according to claim 1, wherein the controller starts charging by the charging-discharging module until a preset offset time is reached and controls the airflow of each of the plurality of blowers to a preset offset airflow.

8. The charging-discharging apparatus according to claim 1, wherein the controller repeatedly measures the temperature of the plurality of arrangement regions by the plurality of temperature sensors every time a preset measurement cycle elapsed.

9. A method for controlling a charging-discharging apparatus, which includes a stage portion for accommodating a plurality of battery cells, a charging-discharging module configured to charge and discharge each of the plurality of battery cells, and a plurality of blowers configured to blow outside air toward the plurality of battery cells with the plurality of battery cells interposed therebetween, comprising:
a step of measuring each measured temperature of a plurality of arrangement regions in which battery groups grouping the plurality of battery cells are placed by a temperature sensor disposed on the stage portion; and
a step of controlling the airflow of the plurality of blowers based on each measured temperature.

10. The method according to claim 9, further comprising:
a step of initiating the plurality of blowers and the charging-discharging module; and
a step of controlling the airflow of the plurality of blowers with a preset offset airflow for a preset offset time after the step of initiating the plurality of blowers and the charging-discharging module, prior to the step of measuring each measurement temperature of the plurality of arrangement regions.

11. The method according to claim 9, further comprising:
a step of determining whether charging and discharging of the plurality of battery cells is completed by the charging-discharging module after the step of controlling the airflow of the plurality of blowers based on each measured temperature; and
a step of turning off the operation of the plurality of blowers and the charging-discharging module when the charging and discharging of the plurality of battery cells is completed.

12. The method according to claim 11, wherein the step of measuring each measurement temperature of the plurality of arrangement regions, the step of controlling the airflow of the plurality of blower based on each measurement temperature, and the step of determining whether charging and discharging of the plurality of battery cells is completed are repeated when a preset measurement cycle has elapsed during charging and discharging of the plurality of battery cells.

13. The method according to claim 11, further comprising:
a step of determining a battery cell among the plurality of battery cells in which a temperature deviation or a capacity deviation is above a preset temperature deviation or a preset capacity deviation is defective after the step of turning off the operation of the plurality of blowers and the charging-discharging module.

14. The method according to claim 9, wherein the airflow of each of the plurality of blowers is controlled to a first airflow when the overall average temperature of the plurality of arrangement regions measured by the plurality of temperature sensors is equal to or higher than a predetermined first reference temperature, and the airflow of each of the plurality of blowers is controlled to a second airflow when the overall average temperature of the plurality of arrangement regions measured by the plurality of temperature sensors is equal to or lower than a predetermined second reference temperature in the step of controlling the airflow of the plurality of blowers.

15. The method according to claim 14, wherein the predetermined first reference temperature is 45° C., and the predetermined second reference temperature is 25° C.

16. The method according to claim 14, wherein each airflow of the plurality of blowers is controlled to a third airflow when the overall average temperature of the plurality of arrangement regions is above the predetermined second reference temperature and is below the predetermined first reference temperature and when the sum of the absolute values of the differences between the overall average temperature of the plurality of arrangement regions and each average temperature of the plurality of arrangement regions is equal to or higher than a preset reference difference value, and each airflow of the plurality of blowers is controlled to a fourth airflow when the sum of the absolute values of the differences between the overall average temperature of the plurality of arrangement regions and each average temperature of the plurality of arrangement regions is less than a preset reference difference value in the step of controlling the airflow of the plurality of blowers.

17. The method according to claim 16, wherein the reference difference value is 0.2° C.

18. The method according to claim 14, wherein the airflow of each of the plurality of blowers is controlled to a third airflow when the overall average temperature of the plurality of arrangement regions is above the predetermined second reference temperature and is below the predetermined first reference temperature and when each average temperature of the plurality of arrangement regions is equal to or higher than a preset target temperature, and the airflow of each of the plurality of blowers is controlled to a fourth airflow when each average temperature of the plurality of arrangement regions is below the target temperature.
